(19) United States
(12) Patent Application Publication
(10) Pub. No.: US 2001/0027438 A1
(43) Pub. Date: Oct. 4, 2001

(54) Online stocks trading system having automatic loan service functions

(76) Inventor: Jun Hyun Park, Seoul (KR)

Correspondence Address: HARNESS, DICKEY & PIERCE, PLC, P.O. BOX 828, BLOOMFIELD HILLS, MI, 48303, US

(21) Appl. No.: 09/804,958

(22) Filed: Mar. 13, 2001

(30) Foreign Application Priority Data
Mar. 30, 2000 (KR) P2000-16396

(51) Int. Cl. G06F 17/60

(52) U.S. Cl. 705/38; 705/37

(57) ABSTRACT

Disclosed is an online stocks trading system having automatic loan service functions, which can give selling opportunities until a corresponding date when money is required in order to secure more opportunities for grasping selling timings of home trading system users, and which can immediately secure cash after stocks selling by providing short-term loan services with a collateral of the selling money of the selling date.

The present invention reads in information on the users' accounts and selling information on selling prices, selling amounts, and selling dates of the corresponding stocks in case that the users sell the stocks they hold and apply for secured loans regarding the stocks selling amounts, calculates settlement dates and amounts based on the selling information, transfers to the accounts of the users the amounts corresponding to all or part of calculated settlement money to provide loaned amounts, and repays the loaned money by withdrawing as many amounts as loaned to the corresponding users out of the settlement amounts deposited to the users' accounts if the settlement dates fall due.

### BACKGROUND OF THE INVENTION

1. Field of the Invention

The present invention relates to an online stocks trading system, and more particularly to an online stocks trading system having automatic loan service functions, capable of giving selling opportunities until a corresponding date when money is required in order to secure more opportunities for grasping selling timings of home trading system users, and of immediately securing cash after stocks selling by providing short-term loan services with a collateral of the selling money of the selling date.

2. Description of the Prior Art

In general, the internet is an open-type network constituted for anyone, from anywhere all over the world, to be used with free connections to the other computers by applying a common protocol of the TCP/IP (Transmission Control Protocol/Internet Protocol), available for diverse services such as basic text information transfer, multimedia information together with developments of compression technologies, electronic mails, file transfers, World Wide Web(WWW), and so on.

While local as well as worldwide uses of the internet abruptly increase, the importance of such internet rapidly increases as a strategic tool for the reconsideration of efficiency and productivity throughout all the existing industries. New business opportunities are continuously created through the internet, and the business areas are also expanded, so businessmen who use the internet are gradually increased.

That is, as businesses through the internet in recent, sites of providing diverse contents such as internet advertisements, internet broadcasts, online games, internet newspapers/magazines, search services, portal services, electronic commerce businesses, and so on are rapidly increased.

Of the sites, sites of respective securities companies of providing a home trading system are gradually expanded in trend with explosive concerns of many computer users, in order to buy and sell stocks and the like on a network, and the respective securities companies make their effort for recruiting computer users who try to use the home trading system.

In order for the computer users to perform the stocks trades on a network, the computer users have to install in the users' computers a dedicated emulator for supporting a home trading system which is manufactured and distributed by each of the securities companies, and, in addition, connect to a web page of a particular securities companies opened on the internet or use a mobile communication terminal having a web browser therein.

Further, each of the users executes a dedicated emulator for a home trading system, or connects to a web page of a securities company, and then buys and sells stocks of a desired item by inputting data according to a certain form provided from a main server. At this time, the main server of each securities company can execute in real time stocks trades according to users' key manipulations since the main server is connected to the Stock Exchange.

As stated above, when each user executes stocks trades on a network, in the stocks selling and buying method being performed in general at present, the user sells stocks of a particular item, and, after two days, the user can withdraw selling(or sale) money of the corresponding stocks. Each securities company serves the user to buy stocks of different items with the selling money as substitutional money within the two days during which the selling money can be withdrawn, in order to help the user buy and sell stocks.

However, in case that stocks trades are performed through a conventional home trading system as stated above, since the selling money can be withdrawn after the two days following the time of selling stocks of a particular item each user holds, there exists a problem in that users have to sell stocks they hold two days before they need cash, which eventually causes the reduction of profits since the users sell stocks they hold beforehand due to the time they need cash even though the rising-up of stocks value is anticipated.

### SUMMARY OF THE INVENTION

In order to solve the problem as stated above, it is an object of the present invention to provide an online stocks trading system having automatic loan services, capable of giving selling opportunities till corresponding dates on which users who perform stocks trades require cash in order for the users to select appropriate selling timings, and of immediately securing cash after selling stocks by providing short-term loan service with a collateral of selling money of the selling dates.

In order to achieve the above object, an online stocks trading system having automatic loan service functions comprises a communication network for connecting communication lines among undefined individuals to perform data communications therebetween; plural client personal computers(PCs) having dedicated emulators or web browsers to allow the uses of a home trading system through the communication network, and for outputting to external selling items, selling volumes, and selling prices data that users select and input selling orders of plural menus provided from external after connected to external by executing the dedicated emulators or the web browsers, inputting and displaying on screens data related to secured loan services regarding stocks selling money together with selling result data from the external, and outputting to the external loan applications and loan amount data inputted by the users for using the secured loan services regarding stocks selling money; and a main server for connecting to a stock exchange computer system and selling corresponding stocks according to selling order data inputted by the users of the plural client PCs, outputting to corresponding client PCs data related to the secured loan services regarding the stocks selling money together with selling result data of corresponding stocks of the day, automatically transferring to accounts of corresponding users loan amounts corresponding to all or part of the selling amounts of the day according to the selections of the users of the client PCs, and withdrawing amounts loaned to the corresponding users from settlement amounts deposited to the accounts of the users if settlement dates for the selling money fall due.

Further, an online stocks trading method having automatic loan service functions comprises steps of (1) reading in information on users' accounts and selling information on selling prices, selling volumes, and selling dates of corresponding stocks, in case that the users apply for secured loans regarding stocking selling amounts after selling stocks they hold; (2) calculating settlement dates and settlement amounts based on the selling information on the selling prices, selling volumes, and selling dates read in through the step (1); (3) transferring to the users' accounts amounts corresponding to all or part of settlement amounts calculated through the step (2) to provide the loans; and (4) withdrawing as many amounts as loaned to the users in the step (3) out of settlement amounts deposited to the users' accounts and repaying the loans, if the settlement dates calculated through the step (2) fall due.

### BRIEF DESCRIPTION OF THE DRAWINGS

The above object and other advantages of the present invention will become more apparent by describing in detail a preferred embodiment thereof with reference to the attached drawings, in which:

FIG. 1 is a block diagram for schematically showing a structure of an online stocks trading system having automatic loan service functions according to an embodiment of the present invention;

FIG. 2 is a block diagram for showing in detail a structure of a main server of FIG. 1;

FIG. 3 is a view for explaining an automatic loan timing of the online stocks trading system having automatic loan service functions according to an embodiment of the present invention;

FIG. 4 is a flow chart for showing in detail operation steps of an online stocks trading method having automatic loan service functions according to an embodiment of the present invention; and

FIG. 5 and FIG. 6 are flow charts for showing in detail operation steps of respective subroutines of FIG. 4.

### DETAILED DESCRIPTION OF THE PREFERRED EMBODIMENT

Hereinafter, an online stocks trading system having automatic loan service functions according to an embodiment of the present invention will be described in detail with reference to the attached drawings.

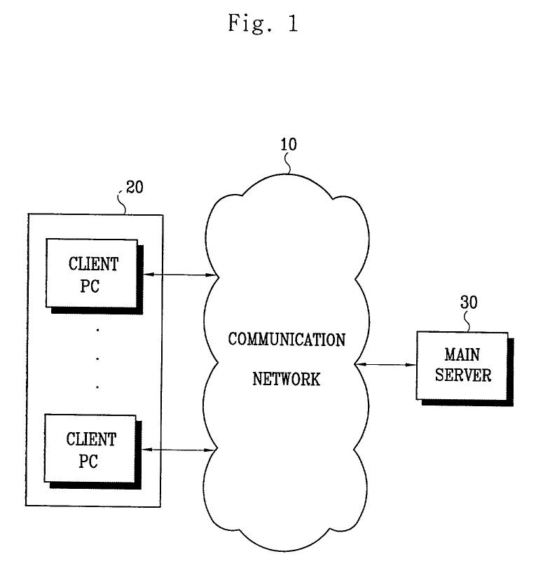

FIG. 1 is a block diagram for schematically showing a structure of an online stocks trading system having automatic loan service functions according to an embodiment of the present invention.

As shown in FIG. 1, a communication network 10 is a communication network such as the internet and the like, which connects plural client personal computers(PCs) 20 and a main server 30, to be described later, to perform data communications related to a short-term loan service with a collateral of stocks selling money therebetween.

The plural client PCs 20 each have dedicated emulators or web browsers built therein to use a home trading system through the communication network 10, and, after executing communication connections to the main server 30 with the dedicated emulators or the web browsers executed, and then output to the main server 30 various stocks selling-related data such as sell items, selling amounts, selling prices, and so on, inputted when users select a selling order out of plural menus provided from the main server 30.

Further, the plural client PCs 20 inputs data related to a collateral loan service of stocks selling money together with selling result data from the main server 30, displays the data on a screen, and outputs to the main server 30 loan applications and loan amount data the users input for using the collateral loan service of the stocks selling money.

The main server 30 is connected to a stock exchange computer system(not shown) and sells corresponding stocks according to selling order data the users of the plural client PCs 20 input, outputs to corresponding client PCs 20 data related to the collateral loan service of the stocks selling money together with selling result data of corresponding stocks on the day.

Further, the main server 30 automatically transfers to corresponding users' accounts loan amounts corresponding to all or part of the selling money of the day according to the selections of the users of the client PCs 20, and, if the settlement dates fall due for the selling money, the amounts loaned to corresponding users are withdrawn from the settlement amounts deposited into the users' accounts.

At this time, in case that the users of the client PCs 20 use the collateral loan service for the stocks selling money, the loan amount to be provided to each user in the main server 30 is performed within a range of settlement amount according to stocks selling, and each user can select all or part of the selling money.

Further, the main server 30 provides menu data that enables users to select loans corresponding to all or part of stocks selling money at the time the users confirm result data for sold stocks, and transfers to users' accounts amounts deducted by a certain interest rate from loan amounts corresponding users request.

Further, a comprehensive agreement among users, stocks companies, and financial companies is necessary to allow immediate loans to the users of the plural client PCs 20 and automatic money withdraws from users' accounts.

In the meantime, the main server 30, in case that the users of the client PCs 20 bears an additional interest on them, can have a service capable of delaying the repayment date of the loaned money.

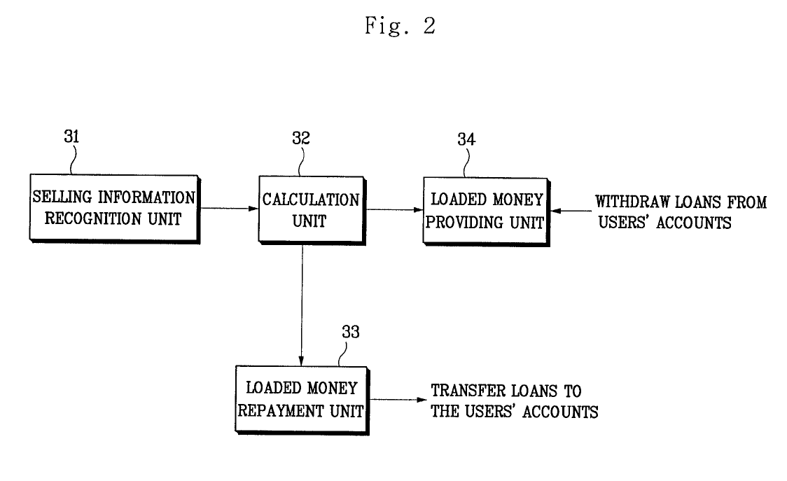

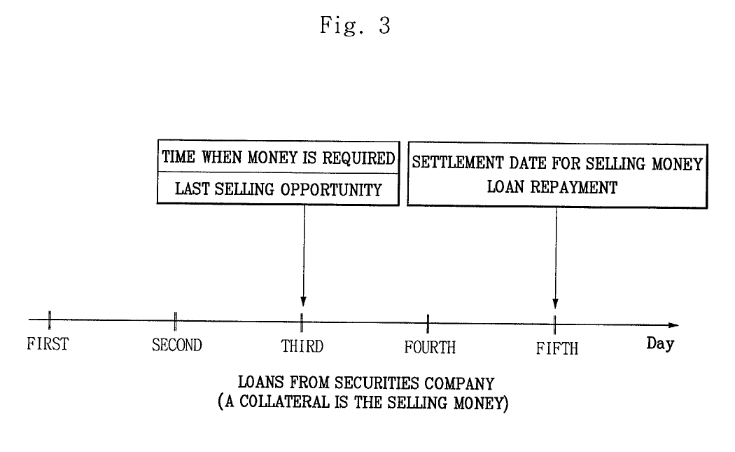

Further, FIG. 2 is a block diagram for showing in detail a structure of the main server 30 of FIG. 3.

As shown in FIG. 2, a selling information recognition unit 31, in case that users of the client PCs 20 sell stocks they hold and then apply for loans secured with stocks selling amounts, reads in various pieces of selling information such as information on corresponding users' accounts, selling prices of corresponding stocks, selling volumes, selling dates, and so on.

A calculation unit 32 calculates settlement dates and settlement amounts of corresponding stocks selling moneys based on the selling information such as the selling prices, selling amounts, and selling dates read in through the selling information recognition unit 31.

A loaned money providing unit 33 provides loaned money by transferring into users' accounts the amounts corresponding to all or part of the settlement amounts of the corresponding stocks selling amounts calculated through the calculation unit 32.

A loaned money repayment unit 34, if the settlement dates for the corresponding stocks selling money fall due, repays the loaned money by withdrawing as much as amounts loaned to the corresponding users from the settlement amounts deposited into users' accounts.

Further, FIG. 3 is a view for explaining an automatic loan timing of the online stocks trading system having automatic loan service functions according to an embodiment of the present invention, wherein, in case that a particular user has the timing he need money falling on the third day of a month, the main server 30 immediately loans out all or part of selling money on the third day with secured selling money according to an application of the user, even though the user does not sell the stocks he hold on the first day but sell the stocks on the second day while viewing a market trend or on the third day when the money is required. Further, if the selling money is deposited into an account of the corresponding user on the fifth day when the selling money has to be settled, the main server 30 withdraws as many amounts as loaded to the corresponding user and then completes the loan service.

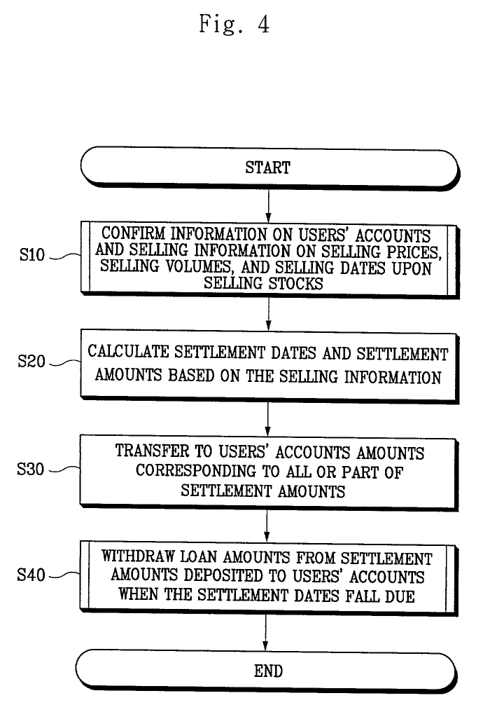

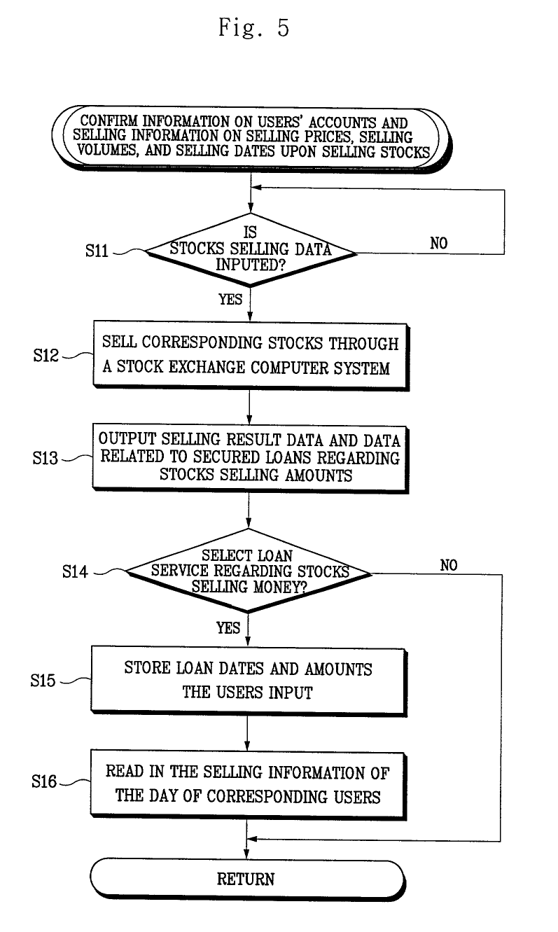

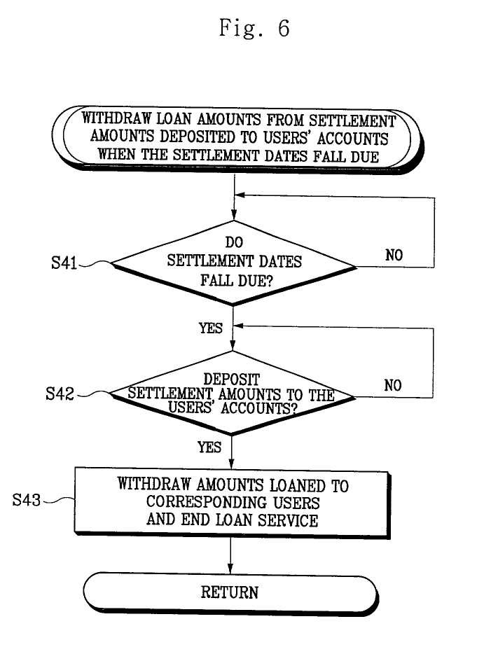

Next, an online stocks trading method having automatic loan service functions according to a preferred embodiment of the present invention having the above structure will be concretely described with reference to FIG. 4 to FIG. 6.

FIG. 4 to FIG. 6 are flow charts for showing in detail operation steps of an online stocks trading method having automatic loan service functions according to an embodiment of the present invention.

First of all, if the users of the client PCs 20 sell stocks they hold through a home trading system and applies for secured loans for stocks selling amounts, the selling information recognition unit 31 of the main server 30 reads in information on accounts of the corresponding users and selling information on selling prices, selling volumes, and selling dates of corresponding stocks(S10).

Describing in detail the above, the main server 30 judges if the users of the client PCs 20 input data for selling stocks of particular items(S11), and sells the corresponding stocks through a Stock Exchange computer system according to the stocks selling data inputted by corresponding users(S12).

Further, the main server 30 outputs to the corresponding client PCs 20 data related to a secured loan service together with selling result data executed through the Stock Exchange computer system(S13), and judges if the corresponding users of the client PCs 20 select the secured loan service regarding stocks selling money(S14).

As a result of the judgement, if the secured loan service for the stocks selling money is selected by the corresponding users of the client PCs 20, the main server 30 stores loan dates and loan amounts inputted by the users(S15), and reads in information on accounts of the corresponding users and selling information on selling prices, selling volumes, and selling dates(S16).

After reading in the selling information on the selling prices, selling volumes, and selling dates according to the secured loan service for the stocks selling money of the users of the client PCs 20 through the above step S10, settlement dates and settlement amounts are calculated based on the stocks selling information of the corresponding users through the calculation unit 32 of the main server 30(S20).

Further, amounts corresponding to all or part of settlement amounts calculated through the above step S20 are transferred to accounts of the users to pay the loans through the loaned money providing unit 33(S30).

At this time, the loan transferred to the accounts of the users of the client PCs 20 from the main server 30 are provided after an interest amount at a certain rate is deducted.

Further, if the secured loans regarding the stocks selling money is performed for the corresponding users in the above step S30, the main server 3 does not calculate the stocks selling money of the corresponding users as substitutional money, so that the users of the client PCs 20 can not buy other stocks.

Now, if the settlement dates calculated through the above step S20 fall due, the main server 30 withdraws as many amounts as loaned to the users in the above step S30 from the settlement amounts deposited to the users' accounts to perform the repayments of loans(S40).

Describing in detail the above, the main server 30 judges if the settlement dates according to the stocks selling of particular users of the client PCs 20 which have used the secured loan regarding stocks selling money fall due(S41), and, if the settlement dates fall due, judges if the settlement amounts are deposited into the accounts of the corresponding users(S42).

As a result of the judgement, if the settlement amounts are deposited into the accounts of the users of the client PCs 20, the main server 30 withdraws the amounts loaned to the corresponding users through the loaned money repayment unit 34 and ends the load service(S43).

At this time, in the above step S40, in case that particular users of the client PCs 20 pay extra interest at the time the users repay the loaned money, the main server 30 can be operated to delay the repayment dates of the loans.

As stated above, in the online stocks trading system having automatic loan service functions according to the present invention, since the securities companies can provide short-term loan services in a collateral of stocks selling money of each user, the stocks selling can be performed by selecting stocks selling time periods till the time when money is required by the users who performs stocks investments by using a home trading system, so there is an effect of providing a more comfortable investment environment.

Further, since each securities company can provides the users with the selling money to be settled in predetermined days after selling stocks and charge a certain fee, there exists an effect in that a new income source can be created in addition to the fees from the stocks buying and selling, the providing of distinct service can enhance the satisfaction degree of the existing clients, and positive factors can be made for brand-new customer creation.

As stated above, although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. an online stocks trading system having automatic loan service functions wherein stocks trades are executed through a communication network and computers, comprising:
a communication network for connecting communication lines among undefined individuals to perform data communications therebetween;
plural client personal computers(PCs) having dedicated emulators or web browsers to allow the uses of a home trading system through the communication network, and for outputting to external selling items, selling volumes, and selling prices data that users select and input selling orders of plural menus provided from external after connected to external by executing the dedicated emulators or the web browsers, inputting and displaying on screens data related to secured loan services regarding stocks selling money together with selling result data from the external, and outputting to the external loan applications and loan amount data inputted by the users for using the secured loan services regarding stocks selling money; and
a main server for connecting to a stock exchange computer system and selling corresponding stocks according to selling order data inputted by the users of the plural client PCs, outputting to corresponding client PCs data related to the secured loan services regarding the stocks selling money together with selling result data of corresponding stocks of the day, automatically transferring to accounts of corresponding users loan amounts corresponding to all or part of the selling amounts of the day according to the selections of the users of the client PCs, and withdrawing amounts loaned to the corresponding users from settlement amounts deposited to the accounts of the users if settlement dates for the selling money fall due.

2. The online stocks trading system as claimed in claim 1, wherein the main server includes:
a selling information recognition unit for reading in information on the users' accounts and selling information on selling prices, selling amounts, and selling dates of the corresponding stocks in case that the users sell the stocks they hold and apply for secured loans regarding the stocks selling amounts;
a calculation unit for calculating settlement dates and amounts based on the selling information on the selling prices, selling volumes, and selling dates read in through the selling information recognition unit;
a loaned money providing unit for transferring to the accounts of the users the amounts corresponding to all or part of settlement money calculated through the calculation unit and providing loans; and
a loaned money repayment unit for repaying the loaned money by withdrawing as many amounts as loaned to the corresponding users out of the settlement amounts deposited to the users' accounts if the settlement dates fall due.

3. The online stocks trading system as claimed in claim 1 or claim 2, wherein the main server, at the time when the users of the client PCs confirm result data they sell stocks, provides menu data of allowing to select loans of all or part of the stocks selling money, and transfers to the users' accounts amounts deducted by interest amounts of a certain rate from loan amounts requested by corresponding users.

4. An online stocks trading method having automatic loan service functions wherein stocks trades are executed through a communication network and computers, comprising steps of:
(1) reading in information on users' accounts and selling information on selling prices, selling volumes, and selling dates of corresponding stocks, in case that the users apply for secured loans regarding stocking selling amounts after selling stocks they hold;
(2) calculating settlement dates and settlement amounts based on the selling information on the selling prices, selling volumes, and selling dates read in through the step (1);
(3) transferring to the users' accounts amounts corresponding to all or part of settlement amounts calculated through the step (2) to provide the loans; and
(4) withdrawing as many amounts as loaned to the users in the step (3) out of settlement amounts deposited to the users' accounts and repaying the loans, if the settlement dates calculated through the step (2) fall due.

5. The online stocks trading method as claimed in claim 4, wherein the step (1) includes steps of:
(1-1) judging if stocks selling data of particular items the users of the client PCs input is inputted to a main server;
(1-2) selling corresponding stocks through a stock exchange computer system according to stocks selling data inputted by the users;
(1-3) outputting to corresponding client PCs data related to the secured loan services regarding stocks selling money together with selling result data executed in the main server;
(1-4) judging if the users of the corresponding client PCs select the secured loan services regarding stocks selling money;
(1-5) storing loan dates and loan amounts inputted by the users if the secured loan services regarding stocks selling money are selected by the users; and
(1-6) reading in the information on the accounts of the corresponding users and the selling information on selling prices, selling amounts, and selling dates.

6. The online stocks trading method as claimed in claim 4, wherein the step (4) includes steps of:
(4-1) judging if the settlement dates according the stocks selling of particular users of the client PCs who use the secured loans regarding the stocks selling money fall due;
(4-2) judging if settlement amounts are deposited to accounts of the corresponding users when the settlement dates fall due; and
(4-3) withdrawing the amounts loaned to the corresponding users and ending the loan services if the settlement amounts are deposited to the users' accounts.

7. The online stocks trading method as claimed in claim 4, wherein, in the step (3), the loaned amounts transferred to the users' accounts are provided after deductions of interest amounts at a certain rate.

8. The online stocks trading method as claimed in claim 4, wherein, in the step (3), if the secured loans regarding the stocks selling amounts are performed, the stocks selling amounts of the corresponding users are not calculated as substitutional amounts, and nor are stocks bought with the stocks selling amounts.

9. The online stocks trading method as claimed in claim 4, wherein, repayment dates for the secured loans can be delayed if extra interests are payed by the users.
